(19) United States
(12) Patent Application Publication
(10) Pub. No.: US 2013/0269914 A1
(43) Pub. Date: Oct. 17, 2013

(54) Heat Exchanger for Refrigeration Cycle and Manufacturing Method for Same

(71) Applicants: Terumasa Matsumoto, Hachioji-shi (JP); Takashi Chino, Itabashi-ku (JP); Makoto Kusama, Tsukubamirai-shi (JP)

(72) Inventors: Terumasa Matsumoto, Hachioji-shi (JP); Takashi Chino, Itabashi-ku (JP); Makoto Kusama, Tsukubamirai-shi (JP)

(21) Appl. No.: 13/879,600

(22) PCT Filed: Oct. 11, 2011
(86) PCT No.: PCT/JP2011/073331

§ 371 Date: Jun. 28, 2013

(30) Foreign Application Priority Data
Oct. 14, 2010 (JP) 2010-231617
Dec. 1, 2010 (JP) 2010-268579
Jan. 18, 2011 (JP) 2011-007757

(51) Int. Cl. F28D 15/04; B23P 15/26

(52) U.S. Cl. CPC F28D 15/04; B23P 15/26
USPC 165/104.26; 29/890.035

(57) ABSTRACT

A heat exchanger for a refrigeration cycle that in terms of functionality and quality is within the allowable range of and comparable to a conventional heat exchanger for a refrigeration cycle, has substantially the same structure as a conventional heat exchanger for a refrigeration cycle, and enables reduced costs, as well as method for manufacturing the heat exchanger are provided. A heat exchanger for a refrigeration cycle is configured so that a refrigerant discharged from a compressor is circulated to a condenser, a capillary tube, an evaporator, a suction pipe, and the compressor, and so that the external surfaces of the capillary tube and the suction pipe are thermally in contact with each other. The material of the capillary tube and the suction pipe is aluminum. The locations at which the external surfaces of the capillary tube and the suction pipe are joined where fillets of a brazing material being an Al—Si alloy and a Zn—Al alloy are formed.

### CROSS-REFERENCE TO RELATED APPLICATIONS

This application is a National Stage application of International Application No. PCT/JP2011/073331, filed on Oct. 11, 2011, which claims priority of Japanese application Serial Number 2010-231617 filed on Oct. 14, 2010, Japanese application Serial Number 2010-268579 filed on Dec. 1, 2010 and Japanese application Serial Number 2011-007757 filed on Jan. 18, 2011, all of which are incorporated herein by reference in their entireties.

### BACKGROUND OF THE INVENTION

1. Field of the Invention

The present invention relates to a heat exchanger for a refrigeration cycle used in, for instance, refrigerators, and a manufacturing method for the same.

2. Background Art

In general, a refrigerator has a refrigeration cycle that refrigerant discharged from a compressor passes through a condenser, capillary tube, an evaporator, and a suction pipe in order and returns to the compressor.

The refrigerant compressed in the compressor is converted into gas of high temperature and pressure and sent to the condenser, and radiates heat in the condenser so as to be liquefied. The liquefied refrigerant is sent to the evaporator after passing through the capillary tube. The liquefied refrigerant sent from the capillary tube to the evaporator is evaporated by the evaporator and takes heat around the refrigerant so as to generate cold air. The evaporated refrigerant passes through the suction pipe, and then, returns to the compressor so as to be compressed again.

In the above refrigeration cycle, the refrigerant passing through the capillary tube has relatively high temperature. In order to improve cooling efficiency, it is effective to reduce temperature of the refrigerant introduced into the evaporator from the capillary tube. For this, well-known is a method of abutting the suction pipe in which refrigerant of relatively lower temperature flows on the capillary tube. That is, heat exchange is carried out between the refrigerant of the suction pipe and the refrigerant of the capillary tube so as to reduce the temperature of the refrigerant flowing in the capillary tube. In order to connect the capillary tube and the suction pipe with each other in the heat exchanger for the refrigeration cycle, a method of soldering the capillary tube and the suction pipe in a state where they abut on each other in parallel has been frequently used.

The capillary tube is generally a thin tube which is about Φ0.6 mm to Φ0.8 mm in inner diameter and is about Φ2.0 mm to Φ3.0 mm in outer diameter, and the suction pipe is a round pipe which is about Φ4.5 mm to Φ6.5 mm in inner diameter and is about Φ6.0 mm to Φ8.0 mm in outer diameter. Moreover, the capillary tube and the suction pipe are respectively about 2,000 mm to 5,000 mm in length, but their lengths may be changed according to sizes of refrigerators.

In the case of heat exchangers for the refrigeration cycle equipped in refrigerators on the market all over the world including Japan, the suction pipe made of copper and the capillary tube made of copper are joined integrally with each other in a state where their external surfaces are in thermal contact with each other. The copper-made suction pipe and the copper-made capillary tube have been practically applied up to now because they have high heat-exchanging efficiency and excellent corrosion resistance and are easy to be connected integrally by soldering.

Various patent documents, for instance, the patent documents 1, 2 and 5 respectively disclose improved heat exchangers, in which a copper-made suction pipe and a copper-made capillary tube are in thermal contact with each other by soldering. Moreover, the patent document 7 discloses a heat exchanger in which a copper-made suction pipe and a copper-made capillary tube are in thermal contact with each other by seam welding.

In the patent document 3, materials for the suction pipe and the capillary tube are not described, but judging by the description, “the capillary tube is soldered with the suction pipe to form a counter current flow heat exchanger”, it seems that the suction pipe and the capillary tube are respectively made of copper. In the patent document 5, the material for the capillary tube is not described, but judging by the description, “the suction pipe and the capillary tube are in thermal contact with each other to a predetermined distance by soldering so as to heat-exchange each other and the portion of the suction pipe, which gets in thermal contact with the capillary tube, is made of metal such as copper”, it seems that the capillary tube is also made of copper. Such a view that the suction pipe and the capillary tube of the heat exchanger described in the patent documents 3 and 5 are all made of copper can be sufficiently accepted through the description of paragraph [0011] to [0012] in the patent document 6, “In order to connect the suction pipe and the capillary tube, soldering is generally carried out using tin(Sn). Moreover, in order to improve heat-exchanging efficiency and corrosion resistance between the suction pipe and the capillary tube, the suction pipe and the capillary tube are generally made of copper.”

The patent document 1 relates to a refrigerator which carries out heat-exchanging between the suction pipe and the capillary tube. The capillary tube and the suction pipe are all made with copper pipes, and are in thermal contact with each other by soldering in a state where they are attached to each other in parallel.

The patent document 2 relates to an improved multiplex heat exchanger used in refrigerators. The multiplex heat exchanger includes a fluid flow pipe (outer pipe) and another fluid flow pipe (inner pipe) arranged inside the outer pipe, and carries out heat-exchange of a fluid. In the patent document 2, it is described that preferably, the fluid flow pipe (outer pipe), which corresponds to the suction pipe, and the fluid flow pipe (inner pipe), which corresponds to the capillary tube, are made of copper or copper alloy which has excellent plastic working, thermal conductivity, brazing performance, soldering performance, and corrosion resistance, and so on.

The patent document 3 relates to a refrigerator which carries out heat-exchanging between the suction pipe and the capillary tube. The capillary tube and the suction pipe are attached to each other in parallel and soldered to form the counter current flow heat exchanger.

The patent document 4 relates to a heat exchanger applicable to a refrigeration circuit of a refrigerator. The heat exchanger uses a capillary tube made of copper alloy and a suction pipe made of aluminum alloy. Because the capillary tube and the suction pipe are made of metal of different kinds, if moisture is attached to the heat exchanger, a local cell is formed between the different metals, and hence, the heat exchanger may be corroded. Therefore, in a state where the copper alloy-made capillary tube and the aluminum alloy-made suction pipe are attached to each other in parallel, melted aluminum-silicon series brazing filler metal is poured onto the capillary tube and the suction pipe and is coagulated. Accordingly, the copper alloy-made capillary tube and the aluminum alloy-made suction pipe are joined together thermally, and at the same time, the outer circumferences of the capillary tube and the suction pipe are continuously covered with the brazing material.

The patent document 5 relates to a refrigeration system for preventing dew condensation by the refrigeration cycle. Because the suction pipe is made of metal such as copper which has excellent thermal conductivity, dew condensation is likely to occur. In order to solve the above problem, a part of the suction pipe is made of resin with thermal conductivity lower than metal such as copper. The suction pipe and the capillary tube are in thermal contact with each other to a predetermined distance by soldering so as to carry out heat-exchange. The thermal contact portion of the suction pipe is made of metal such as copper, but the remaining portion except the thermal contact portion is made of resin with high gas barrier efficiency.

The patent document 6 relates to a suction pipe assembly with an improved thermal conductivity. The suction pipe assembly includes a capillary tube disposed therein and a heat transfer pipe having a contact portion disposed on the outside of the suction pipe assembly for widening a contact area with a suction pipe, and the contact portion of the heat transfer pipe is connected to the outer circumference of the suction pipe by thermally conductive adhesives. Because the contact area between the heat transfer pipe and the suction pipe is increased, heat-exchange is effectively carried out between refrigerant moving in the suction pipe and refrigerant moving in the capillary tube inserted into the heat transfer pipe. The capillary tube is made of copper, but may be made of aluminum or steel, and the heat transfer pipe may be made of aluminum or one of various materials. The suction pipe may be made of copper or aluminum, but it is preferable that the suction pipe is made of steel which has excellent machinability and bending property and is relatively inexpensive. If the suction pipe is made of steel and is plated with a corrosion-resistant material, an industrially applicable suction pipe with corrosion resistance can be made. In the embodiment of the patent document 6, the steel-made suction pipe, the copper-made capillary tube, and the aluminum-made heat transfer pipe are used.

The patent document 7 relates with a method for connecting a suction pipe and a capillary tube in a thermal contact with each other by welding. In detail, a part of the suction pipe protrudes from the outer circumferential surface of a copper pipe of the suction pipe by plastic deformation, so that a pair of protrusions extending in the pipe axis direction are formed at a spaced interval, which is almost equal to the outer diameter of the capillary tube, in a circumferential direction. After that, the copper pipe of the capillary tube is arranged between the protrusions, and the protrusions are joined to the capillary tube by seam welding.

### CITED REFERENCE

Japanese Patent Laid-open No. 2002-130912

Japanese Patent Laid-open No. 2006-292182

Japanese Patent Laid-open No. 2008-121980

Japanese Patent Laid-open No. 2008-267757

Japanese Patent Laid-open No. 2009-41810

Japanese Patent Publication No. 2010-525297

Japanese Patent Laid-open No. 2001-248979

### SUMMARY OF THE INVENTION

Cost reduction of products is a permanent task in the manufacturing industry. If cost reduction of the heat exchangers for the refrigeration cycle is realized, cost reduction of refrigerators as products can be also realized. In order to realize the cost reduction of the refrigerators as the products, it is demanded that functions and quality of the heat exchanger suffer nothing by comparison with a conventional heat exchanger within a permissible range. Moreover, people should avoid improving the heat exchanger so as to change the structure into a refrigeration cycle system or changing the entire structure of the refrigerator. For this, the improved heat exchanger must has substantially the same structure as a conventional heat exchanger, namely, the shapes of the suction pipe and the capillary tube, for instance, the inner diameter, the outer diameter, the length of the pipe or the tube) of the heat exchanger must be kept in the permissible range.

The inventors of the present invention have judged that it was possible to provide a cost-reducible heat exchanger for a refrigeration cycle, which suffers nothing by comparison with a conventional heat exchanger with the refrigeration cycle, has the same structure as a conventional heat exchanger for the refrigeration cycle in fact, if the suction pipe and the capillary tube may be made of aluminum instead of copper, the heat exchanger for the refrigeration cycle.

In the case that the base materials, which have extremely different diameters, like the suction pipe and the capillary tube are soldered or brazed, it is preferable to use a soldering material or a brazing material having a large difference in melting point between the base materials and the soldering material or the brazing material. In the case of soldering, because there is a large difference in melting point between an aluminum material which is the base material and the soldering material, the external surface of the suction pipe and the external surface of the capillary tube can be connected with each other without any influence on the base material. However, the heat exchanger for the refrigeration cycle in which the aluminum-made suction pipe and the aluminum-made capillary tube are joined with each other by aluminum soldering (for instance, Sn—Zn alloy) has a problem in corrosion resistance, and hence, cannot avoid deterioration of the connected portion under usage environment, and needs a anticorrosion treatment in order to prevent the deterioration.

In the case that aluminum materials are bonded by a brazing material selected from Al—Si alloy or Zn—Al alloy, it has no problem in corrosion resistance, and hence, does not need the anticorrosion treatment for protecting the bonded portion. However, in the case that a thin aluminum-made capillary tube with length of 2,000 mm to 3,000 mm and an extremely thick aluminum-made suction pipe are attached with each other in parallel and heated, it is difficult to raise heat of the suction pipe and the capillary tube to the same temperature due to a thermal capacity difference between the suction pipe and the capillary tube, and if the brazing temperature is raised to a proper temperature, the thin capillary tube may be overheated to thereby be melted and damaged.

In the patent document 7, the copper-made suction pipe and the copper-made capillary tube are joined with each other by seam welding. In order to connect the copper-made suction pipe and the copper-made capillary tube with each other, welding such as seam welding or arc welding may be applied. However, if an aluminum-made suction pipe and an aluminum-made capillary tube are used instead of the copper-made suction pipe and the copper-made capillary tube, it is impossible to connect them by seam welding or arc welding.

The reason is as follows. Because the specific heat (0° C.) of copper is 0.880 J/g·K, the specific heat (0° C.) of aluminum is 0.379 J/g·K, the specific gravity (20° C.) of copper is 8.96, and the specific gravity (20° C.) of aluminum is 2.71, the copper-made suction pipe is 7.7 times more in thermal capacity than the aluminum-made suction pipe, and likewise, the copper-made capillary tube is 7.7 times more in thermal capacity than the aluminum-made capillary tube. Accordingly, even though the same thermal capacity is applied, the copper material is less in temperature change than the aluminum material. Furthermore, because the melting point of copper is about 1083° C. and the melting point of the aluminum is about 660° C., it is possible to connect the copper-made suction pipe and the copper-made capillary tube with each other by seam welding or arc welding, but if the aluminum-made suction pipe and the aluminum-made capillary tube are joined with each other by seam welding or arc welding, the thin capillary tube may be overheated to thereby be melted and damaged.

For reasons mentioned above, till now, in my opinion, there has been no proposal of the heat exchanger for the refrigeration cycle using the aluminum-made capillary tube and the aluminum-made suction pipe.

Accordingly, the present invention has been made to solve the above-mentioned problems occurring in the prior arts, and it is an object of the present invention to provide a heat exchanger for a refrigeration cycle and a manufacturing method of the heat exchanger, which includes a suction pipe and a capillary tube respectively made of aluminum, instead of the copper-made suction pipe and the copper-made capillary tube of a conventional heat exchanger for the refrigeration cycle, thereby suffering nothing in functions and quality within the permissible range by comparison with a conventional heat exchanger for the refrigeration cycle, having substantially the same structure as a conventional heat exchanger, providing excellent productivity, and reducing manufacturing costs.

The inventors have judged that if a brazing temperature can be raised to a proper temperature uniformly in a state where a brazing material selected from Al—Si alloy or Zn—Al alloy is supplied to the connected portion and the aluminum-made suction pipe and the aluminum-made capillary tube which are coated with flux are attached to jigs in parallel, it could solve the problem that the capillary tube is overheated to thereby be melted and damaged, and hence, invented the present invention.

To achieve the above objects, the present invention provides a heat exchanger for a refrigeration cycle, which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, wherein the capillary tube and the suction pipe are all made of aluminum material, and the locations at which the external surface of the capillary tube and the external surface of the suction pipe are joined are in a state where fillets of a brazing material selected from an Al—Si alloy and a Zn—Al alloy are formed.

In another aspect of the present invention, the present invention provides a manufacturing method of a heat exchanger for a refrigeration cycle, which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, including: 1) a process of preparing a work piece on a jig: (a) the work piece is arranged on the jig in a state where the aluminum-made suction pipe and the aluminum-made capillary tube are attached in parallel; and (b) the work piece is coated with flux to which a brazing material selected from an Al—Si alloy or a Zn—Al alloy is supplied; 2) a process of inserting the work piece prepared on the jig into a brazing furnace preheated; 3) a process of heating the work piece and melting the brazing material so as to form fillets at the portion where the suction pipe and the capillary tube are joined with each other; and 4) a process of cooling the work piece so as to coagulate the fillets.

In the case that the aluminum-made suction pipe and the aluminum-made capillary tube are brazed by the high frequency induction heating method, when high frequency induction heating is carried out, if the external surface of the suction pipe and the external surface of the capillary tube which are attached in parallel are in contact with each other, because temperature of the suction pipe becomes almost equal to temperature of the capillary tube, even though the brazing temperature is raised to a proper temperature, the thin capillary tube is not melted and damaged due to overheat.

According to the second manufacturing method of the heat exchanger for the refrigeration cycle, the present invention provides a manufacturing method of a heat exchanger for a refrigeration cycle, which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, wherein a brazing material selected from Al—Si alloy or Zn—Al alloy is supplied, and while a work piece, which is in a state where an aluminum-made suction pipe and an aluminum-made capillary tube coated with flux are attached in parallel, moves relatively into a high frequency induction heating coil in a state where the external surfaces of the suction pipe and the capillary tube are welded together with pressure, the external surface of the suction pipe and the external surface of the capillary tube are heated by the high frequency induction heating coil so that the brazing material is melted and fillets are formed at the connected portion of the suction pipe and the capillary tube, and then, the work piece is cooled so as to coagulate the fillets.

The second manufacturing method will be described in more detail. The manufacturing method of a heat exchanger for a refrigeration cycle, which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, including: 1) a process of preparing a work piece on a jig: (a) the work piece is arranged on the jig in a state where the aluminum-made suction pipe and the aluminum-made capillary tube are attached in parallel; and (b) the work piece is coated with flux to which a brazing material selected from an Al—Si alloy or a Zn—Al alloy is supplied; 2) a process of transferring the work piece prepared on the jig to a work piece maintaining device in which a member abutting on the work piece is arranged inside a high frequency induction heating coil: (a) the work piece maintaining device comprises: a suction pipe pressing member pressing the side of the suction pipe, which is one side of the work piece, toward the capillary tube, which is the other side of the work piece; and a capillary tube pressing member pressing the side of the capillary tube toward the suction pipe; 3) a process of transferring the work piece to the high frequency induction heating coil by the work piece maintaining device in the state where the external surfaces of the aluminum-made suction pipe and the aluminum-made capillary tube are welded together with pressure, heating the external surfaces of the suction and the capillary tube by the high frequency induction heating coil so as to melt the brazing material and form fillets at the connected portion of the suction pipe and the capillary tube; and 4) a process of cooling the work piece so as to coagulate the fillets.

In the state where the external surface of the aluminum-made suction pipe and the external surface of the aluminum-made capillary tube are welded together with pressure, the welded portion is heated by a small spot heat source within a short period of time without having any thermal influence on the suction pipe and the capillary tube, and so, the heat exchanger for the refrigeration cycle with excellent heat-exchanging performance can be manufactured.

In other words, in the case that the external surface of the aluminum-made suction pipe and the external surface of the aluminum-made capillary tube are melted and connected together, when laser welding is carried out using laser beams as a heat source in the state where the external surfaces of the suction pipe and the capillary tube are welded together with pressure, the thin capillary tube is not deformed or melted and damaged due to overheat by minimizing a thermal influence on the suction pipe and the capillary tube.

The present invention provides a heat exchanger for a refrigeration cycle which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, wherein the capillary tube and the suction pipe are all made of aluminum material, and the external surface of the capillary tube and the external surface of the suction pipe are joined are in a state where the external surfaces are melted.

According to the second manufacturing method of the heat exchanger for the refrigeration cycle, the present invention provides a manufacturing method of a heat exchanger for a refrigeration cycle, which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, including the steps of: i) pressing an aluminum-made suction pipe and an aluminum-made capillary tube by a pressure jig in a state where they are attached in parallel, so as to weld the external surfaces of the suction pipe and the capillary tube together with pressure; and ii) radiating laser beams to the portion where the external surface of the suction pipe and the external surface of the capillary tube are joined while relatively moving along the laser beams in the state where the external surfaces of the suction pipe and the capillary tube are welded together with pressure, so that the external surfaces are melted and connected together.

In the present invention, “the state where the aluminum-made suction pipe and the aluminum-made capillary tube are attached to each other in parallel” means that the external surface of the aluminum-made suction pipe 105 and the external surface of the aluminum-made capillary tube 103 are arranged side by side in such a way as to abut on each other as shown in FIGS. 4, 7, 13 and 16. Meanwhile, like the first manufacturing method and the second manufacturing method, in the case that the brazing fillet is formed, when a brazing sheet is used as the brazing material, the external surface of the aluminum-made suction pipe 105 and the external surface of the aluminum-made capillary tube 103 are arranged side by side in such a way as to abut on each other through the brazing sheet.

The heat exchanger for the refrigeration cycle according to the present invention suffers nothing in functions and quality within the permissible range by comparison with a conventional heat exchanger for the refrigeration cycle, has substantially the same structure as a conventional heat exchanger, namely, the shapes (inner diameter, outer diameter, and length) of the suction pipe and the capillary tube constituting the heat exchanger are within the permissible range, and enables reduced manufacturing costs because aluminum is nearly ⅓ less in weight cost than copper and nearly ⅓ less in specific gravity than copper. Moreover, in the third manufacturing method, because the external surface of the suction pipe and the external surface of the capillary tube are joined with each other by laser welding, the heat exchanger for the refrigeration cycle can be manufactured on the basis of mass production and remarkably reduce the manufacturing costs because the brazing material is not used.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view showing a structure of a refrigeration cycle using a heat exchanger according to the present invention;

FIG. 2 is a perspective view of the heat exchanger according to the present invention in which fillets are formed and bonded at connected portions;

FIG. 3 is a sectional view of FIG. 2;

FIG. 4 is a perspective view showing a state where a work piece according to the present invention is prepared on a jig used in the first manufacturing method;

FIG. 5 is a sectional view of FIG. 4;

FIG. 6 is a schematic diagram of a brazing furnace used for the first manufacturing method;

FIG. 7 is a perspective view showing a state where the heat exchanger shown in FIG. 2 is manufactured by a high frequency induction heating method which is the second manufacturing method;

FIG. 8 is a front view of FIG. 7;

FIG. 9 is a mimetic diagram showing a state where a work piece maintaining device used in the second manufacturing method presses the work piece;

FIG. 10 is a mimetic diagram showing a state where a suction pipe pressing member and a capillary tube pressing member of the work piece maintaining device respectively press the side of the suction pipe and the side of the capillary tube diagonally downward;

FIG. 11 is a perspective view of the heat exchanger in which the connected portions are melted and connected together;

FIG. 12 is a conceptual diagram of a fiber laser welding machine;

FIG. 13 is a view showing a state where the external surface of the suction pipe and the external surface of the capillary tube are welded with pressure when pressure rollers press the word piece;

FIG. 14 is a mimetic diagram showing the third manufacturing method;

FIG. 15 is an enlarged view showing a state where laser beams (LB) are radiated to the work piece on which the external surface of the suction pipe and the external surface of the capillary tube are welded with pressure;

FIG. 16 is a conceptual diagram showing a method of automatically manufacturing the heat exchanger shown in FIGS. 11; and

FIG. 17 is a photograph of the heat exchanger shown in FIG. 11.

### DETAILED DESCRIPTION OF THE PREFERRED EMBODIMENT

In the present invention, a capillary tube 103 which is made of aluminum is simply named a capillary tube 103, and a suction pipe 105 which is made of aluminum is simply named a suction pipe 105. Moreover, heat exchangers obtained by the first manufacturing method and the second manufacturing method are named as heat exchangers 106A, and a heat exchanger obtained by the third manufacturing method is named as a heat exchanger 106B. The heat exchangers 106A and 106B are generally called a heat exchanger 106.

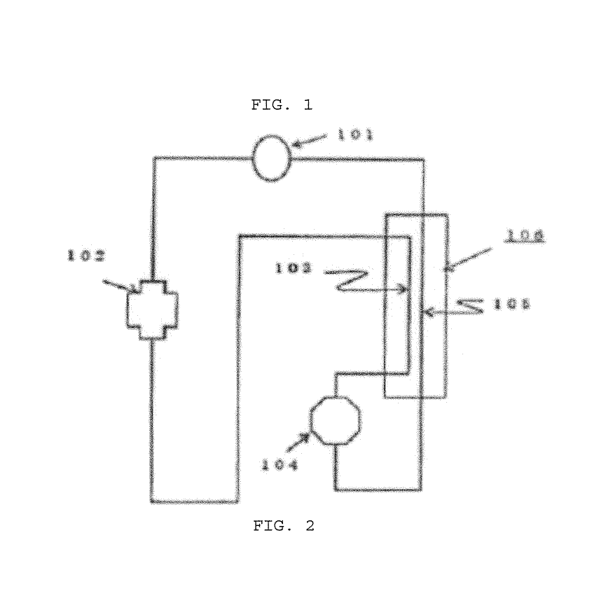

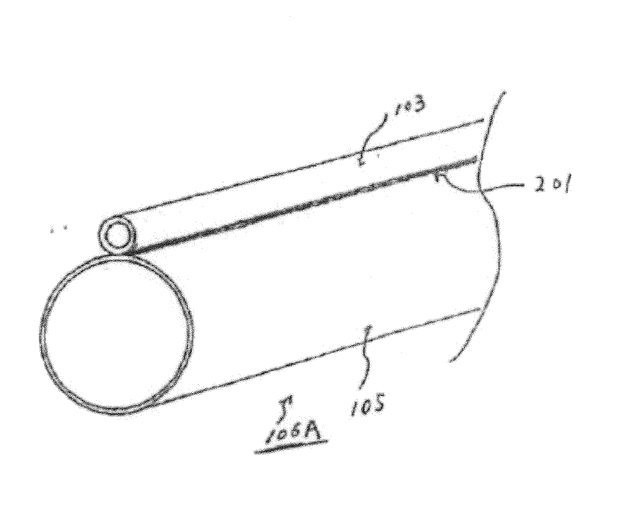

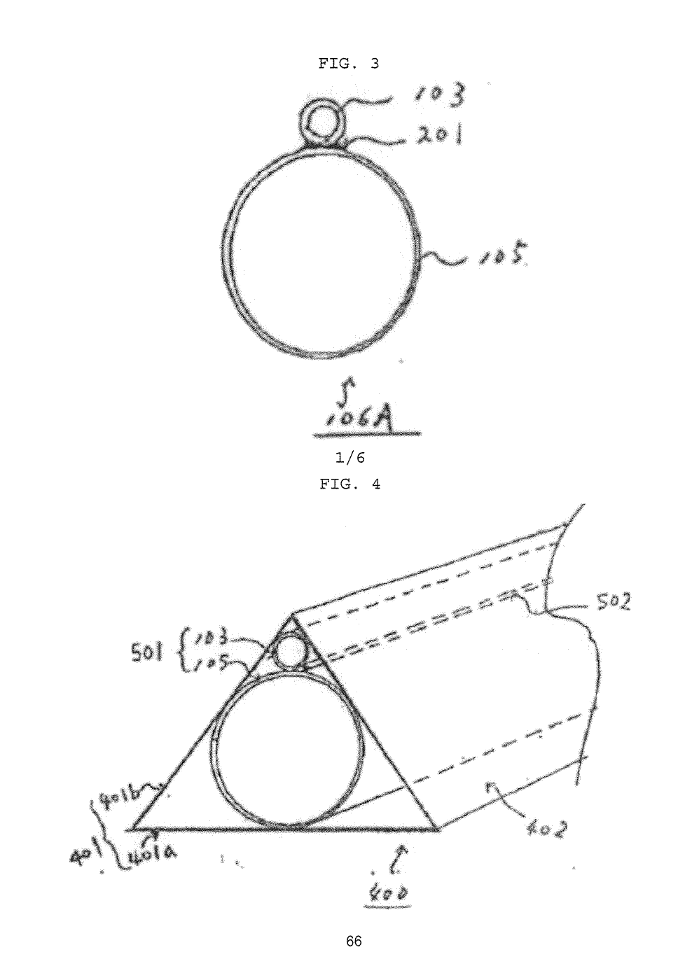

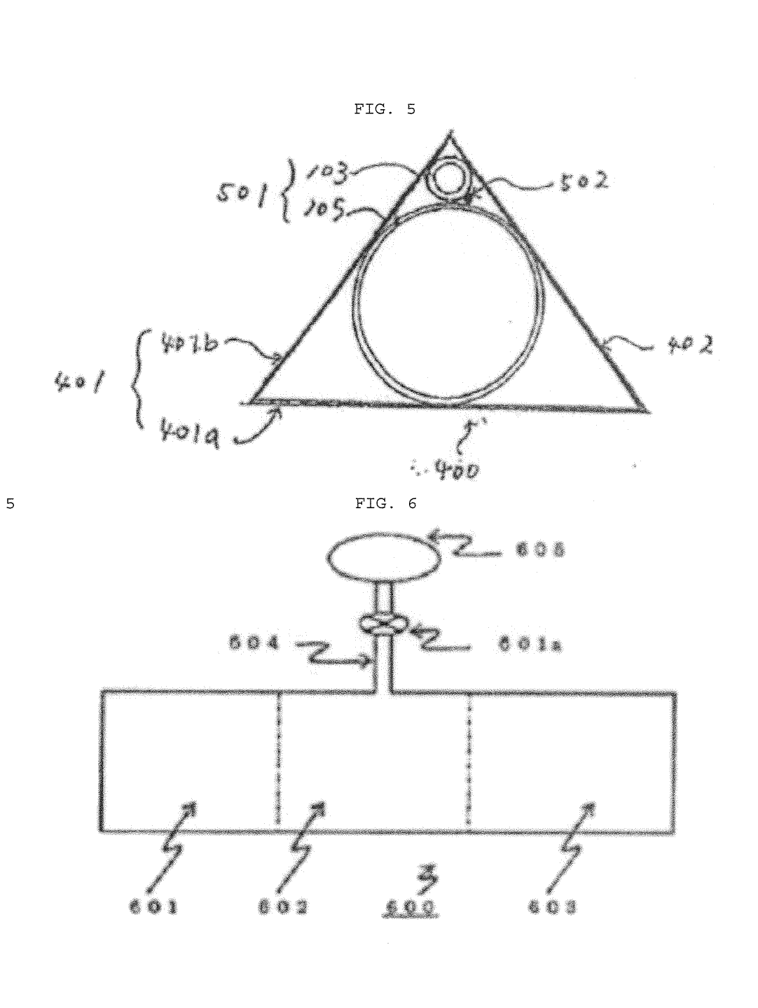

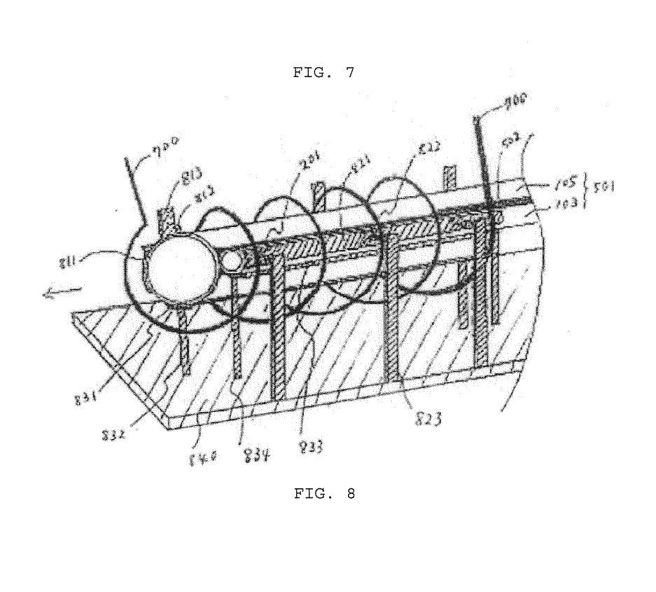

Hereinafter, FIG. 1 is a view showing a structure of a refrigeration cycle using a heat exchanger according to the present invention, FIG. 2 is a perspective view of the heat exchanger according to the present invention in which fillets are formed and bonded at connected portions, FIG. 3 is a sectional view of FIG. 2, FIG. 4 is a perspective view showing a state where a work piece according to the present invention is prepared on a jig used in the first manufacturing method, FIG. 5 is a sectional view of FIG. 4, and FIG. 6 is a schematic diagram of a brazing furnace used for the first manufacturing method.

A refrigeration cycle illustrated in FIG. 1 includes a compressor 101 for sucking and discharging refrigerant; a condenser 102 having an end connected to a refrigerant discharge side of the compressor 101; an aluminum-made capillary tube 103 having an end connected to the other end of the condenser 102; an evaporator 104 having an end connected to the other end of the capillary tube 103; and an aluminum-made suction pipe 105 having an end connected to the other end of the evaporator 104 and the other end connected to a refrigerant suction side of the compressor 101. In the refrigeration cycle, the heat exchanger 106 according to the present invention when the external surface of the aluminum-made suction pipe 105 and the external surface of the aluminum-made capillary tube 103 get in thermal contact with each other.

The refrigeration cycle according to the present invention may further include an accumulator, which is disposed between the evaporator 104 and the suction pipe 105 for separating evaporated gas refrigerant from liquid refrigerant so as to face the gas refrigerant toward the compressor 101, and a drier, which is disposed between the condenser 102 and the capillary tube 103 for removing moisture.

In the heat exchanger 106A, the connected portions of the external surface of the aluminum-made suction pipe 105 and the external surface of the aluminum-made capillary tube 103 are joined in a state where fillets of a brazing material selected from Al—Si alloy or Zn—Al alloy are formed.

The refrigerant compressed in the compressor 101 becomes gas of high temperature and pressure and is sent to the condenser 102, and then, radiates heat in the condenser 102 to be liquefied. The liquefied refrigerant is decompressed while passing through the capillary tube 103 and sent to the evaporator 104, and here, the liquefied refrigerant takes heat around the refrigerant while being evaporated, and hence, the surrounding air is cooled. The evaporated refrigerant of low temperature passes through the suction pipe 105 and returns to the compressor 101 so as to be compressed. It is preferable that the used refrigerant is hydrocarbon-based refrigerant, such as cyclopentane, isobutene, and so on, which is low in coefficient of global warming.

In the refrigeration cycle, because the aluminum-made capillary tube 103 and the aluminum-made suction pipe 105 are in thermal contact with each other, the liquid-phase refrigerant flowing in the capillary tube 103 is cooled by refrigerant of low temperature flowing in the suction pipe 105 so as to improve cooling efficiency.

FIG. 2 is a perspective view of the heat exchanger according to the present invention in which fillets are formed and bonded at the connected portions, and FIG. 3 is a sectional view of FIG. 2. The capillary tube 103 and the suction pipe 105 of the heat exchanger 106A are all made of aluminum. Furthermore, because the connected portions of the external surface of the capillary tube 103 and the external surface of the suction pipe 105 are bonded in a state where fillets 201 of a brazing material selected from Al—Si alloy or Zn—Al alloy are formed, the capillary tube 103 and the suction pipe 105 are in thermal contact with each other.

Except that the capillary tube 103 and the suction pipe 105 of the heat exchanger 106 are made of aluminum, they are almost identical in shape, length, outer diameter and inner diameter with the capillary tube and the suction pipe of the existing freezers, refrigerators, and refrigeration devices. Additionally, the aluminum material for the suction pipe 105 and the capillary tube 103 may be aluminum or aluminum alloy.

In consideration of melting point, thermal conductivity, corrosion resistance of the connected portions, intensity, and workability, Al—Si alloy or Zn—Al alloy is selected as the brazing material. The heat exchanger 106 according to the present invention is mainly applicable to a freezer or a refrigerator, and a recommended period for a replacement cycle of the heat exchanger is somewhat different according to manufacturers, but is about ten years to twelve years. Moreover, according to a survey, 70 percent of those surveyed said that the replacement cycle is more than ten years. Considering the survey, corrosion resistance of the connected portions is an important factor, and hence, it is preferable that the brazing material used in the heat exchanger 106A is Al—Si alloy.

In order to remove an oxidized film on the surface of the aluminum material and improve wettability and liquidity of the melted brazing material, flux is used. CeF flux, chloride flux, and noncorrosive fluoride flux may be used. It is preferable to use the noncorrosive fluoride flux because it does not need washing after the heat exchanger 106A is brazed.

FIG. 4 is a perspective view showing a state where a work piece according to the present invention is prepared on a jig used in the first manufacturing method, FIG. 5 is a sectional view of FIG. 4. The aluminum-made suction pipe 105 and the aluminum-made capillary tube 103 are attached in parallel and arranged on a jig 400 in a state where the external surfaces of the suction pipe 105 and the capillary tube 103 are in contact with each other. The reference numeral 502 designates the brazing material of a thin linear type. The brazing material may be a sheet type brazing material such as a brazing sheet, and in this instance, the suction pipe 105 and the capillary tube 103 are attached together in parallel by the brazing sheet inserted, and then, are arranged on the jig 400. Here, the brazing material is supplied as the third material, but the brazing material may be supplied to the aluminum-made suction pipe or the aluminum-made capillary tube in a clad type.

The work piece 501 according to the present invention is coated with flux. As the flux coating method, there are a coating method using a brush, a spray coating, an impregnation method of impregnating the work piece 501 in a flux liquid, and so on, and hence, one of the methods may be adopted. Furthermore, mixture of the flux and the brazing material, for instance, a paste brazing material in which a powder brazing material is mixed with flux in the form of paste or a flux-containing brazing material in which flux is contained in the brazing material, may be used.

The jig 400 includes an L-shaped jig 401 and a pressure cover 402. The L-shaped jig 401 and the pressure cover 402 may be made of stainless steel. The L-shaped jig 401 is manufactured by a bottom plate 401a and a side plate 401b bonded by laser welding. The jig 400 is about 500 mm to 1,000 mm in length, and a plurality of the jigs may be used according to the length of the work piece 501 in order to prevent deformation due to thermal expansion of the aluminum-made capillary tube 103.

Next, the first manufacturing method which is a brazing method inside a furnace will be described. The suction pipe 105 and the capillary tube 103 are attached to the L-shaped jig 401 in parallel, and then, the Al—Si alloy 502 of the thin linear type is supplied. The noncorrosive fluoride flux (NOCOLOK flux) is coated by a brush, and then, the work piece 501 is fixed by the pressure cover 402. Here, because the aluminum-made suction pipe of 3,000 mm and the aluminum-made capillary tube of 3,000 mm are used, three jigs 400 of 1,000 mm are arranged in series side by side.

FIG. 6 is a schematic diagram of a brazing furnace used for the first manufacturing method. The work piece 501 fixed by the jig 400 is inserted into the brazing furnace 600. In FIG. 6, the brazing furnace 600 is a continuous furnace having a preheating room 601, a brazing room 602, and a cooling room 603. The jig 400 on which the work piece 501 is fixed is set on a returning belt (not shown), and then, the work piece 501 is inserted into the preheating room 601. The preheating room 601 is controlled in such a way as to be always maintained at 320° C. and be heated to 480° C. when the work piece 501 is inserted. The returning speed is varied according to the quantity of the work pieces 501 brazed at once, but is 1 m/minute when there is one set of work pieces.

Next, the work piece 501 preheated in the preheating room 601 is transferred to the brazing room 602 heated at 620° C. to 630° C. Brazing is carried out by heating the work piece 501 to brazing temperature (melting point of the brazing material) by a heat disposed in the brazing room 602. Because Al—Si alloy is used as the brazing material, the brazing temperature is 602° C.±5° C. Because nitrogen gas is introduced from a liquid nitrogen tank 605 through a supply pipe 604 having an opening and closing valve 604a inside the brazing room 602, the inside of the brazing room 602 is kept at a nitrogen gas atmosphere. Oxygen concentration in the nitrogen gas atmosphere is less than 100 ppm, the dew point of the nitrogen gas atmosphere is less than −40° C., and pressure of the nitrogen gas atmosphere is atmospheric pressure. Because the inside of the brazing room 602 is kept at the nitrogen gas atmosphere, it prevents an oxide film from being formed on the surfaces of the aluminum-made suction pipe 105 and the aluminum-made capillary tube 103. By the brazing method using the Al—Si alloy and the noncorrosive fluoride flux, the Ai—Si alloy is melted on the portion where the suction pipe 105 and the capillary tube 103 are joined so as to form the fillets 201, so that the work piece 501 can be connected well. The brazing room 602 is communicated with the preheating room 601 and the brazing room 602 is communicated with the cooling room 603 without any door, and hence, the rooms can be kept in the nitrogen gas atmosphere.

When brazing in the brazing room 602 is finished, the work piece 501 is returned to the cooling room 603 having a water cooling jacket (not shown) and is gradually cooled, so that the fillets 201 formed in the brazing room 602 are coagulated.

When the work piece 501 cooled in the cooling room 603 is returned to the outside of the brazing furnace 600, manufacturing of the heat exchanger 106A is finished. Because there is no pin hole at the connected portion of the aluminum-made suction pipe 105 and the aluminum-made capillary tube 103, brazing is carried out continuously. Furthermore, because the work piece 501 is gradually cooled, a bending process can be easily carried out due to an annealing effect.

The heat exchanger 106A can be manufactured by the high frequency induction heating method because the aluminum-made suction pipe and the aluminum-made capillary tube are heated in the state where the external surfaces of them forcedly abut on each other, namely, in the state where the external surfaces are welded with pressure.

Hereinafter, referring to the drawings, the manufacturing method of the heat exchanger according to the present invention will be described.

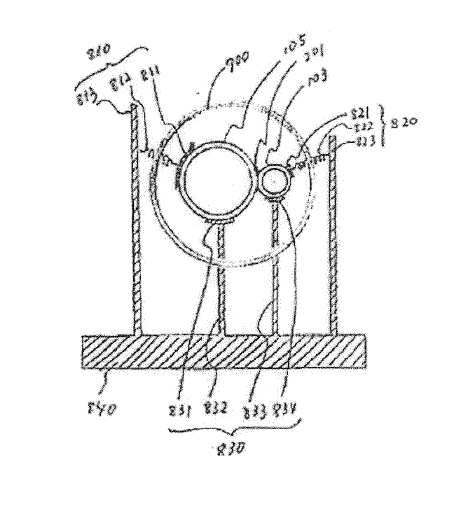

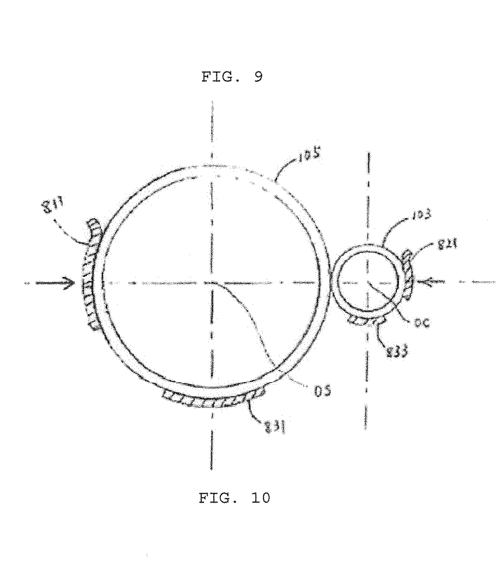

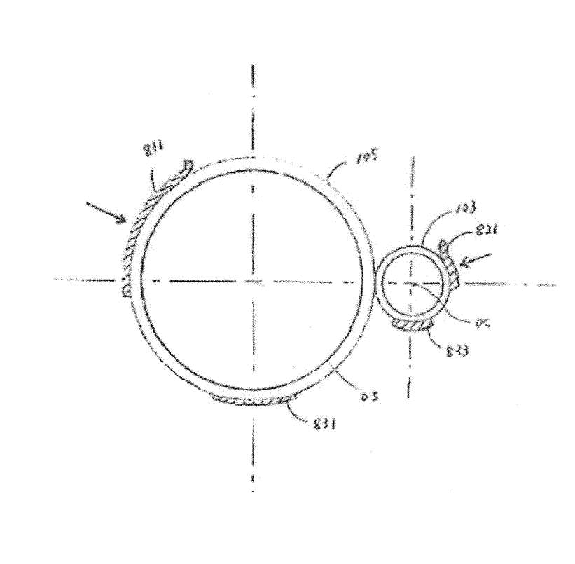

FIG. 7 is a perspective view showing a state where the heat exchanger shown in FIG. 2 is manufactured by a high frequency induction heating method which is the second manufacturing method, FIG. 8 is a front view of FIG. 7, FIG. 9 is a mimetic diagram showing a state where a work piece maintaining device used in the second manufacturing method presses the work piece, and FIG. 10 is a mimetic diagram showing a state where a suction pipe pressing member and a capillary tube pressing member of the work piece maintaining device respectively press the side of the suction pipe and the side of the capillary tube diagonally downward.

In FIG. 7, the work piece 501 prepared on the jig is transferred to a work piece maintaining device, in which a member getting in contact with the work piece 501 is arranged inside a high frequency induction heating coil 700, in an arrow direction (←) (from right to left in the drawing) so as to manufacture the heat exchanger 106A. Like the first manufacturing method, the Al—Si alloy is supplied and the work piece 501 is coated with the noncorrosive fluoride flux. In the meantime, the components of the heat exchanger 106A have the same reference numerals as the heat exchanger according to the first manufacturing method. That is, the reference numeral 103 designates an aluminum-made capillary tube, 105 designates an aluminum-made suction pipe, 501 designates work piece, 201 designates fillets, and 502 designates a brazing material.

Referring to FIG. 8, the work piece maintaining device will be described. The work piece maintaining device includes: a suction pipe pressing member 810, which has a suction pipe contact portion 811, a spring portion 812, and a post 813; and a capillary tube pressing member 820, which has a capillary tube contact portion 821, a spring portion 822, and a post 823. The suction pipe pressing member 810 presses one side of the work piece 501, which is the side of the suction pipe 105, toward the other side of the work piece 501, which is the side of the capillary tube 103. The capillary tube pressing member 820 presses the side of the capillary tube 103 toward the suction pipe 105.

It is preferable that the work piece maintain device has at least one suction pipe pressing member 810 and at least one capillary tube pressing member 820, and may further include a support member 830 for supporting a lower surface of the suction pipe 105 and a lower surface of the capillary tube 103, and in the drawing, the support member 830 includes a suction pipe bottom face supporting portion 831, a suction pipe bottom face post 832, a capillary tube bottom face supporting portion 833 and a capillary tube bottom face post 834, so that the work piece maintain device can maintain the work piece 501 in more safety. The reference numeral 840 designates a floor part for supporting the posts 813, 823, 832 and 834.

In the drawing, the posts 813 and 823 are arranged outside the high frequency induction heating coil 700, but may be arranged inside the high frequency induction heating coil 700. In the present invention, it is essential that during the high frequency induction heating, the external surface of the aluminum-made suction pipe 105 and the external surface of the aluminum-made capillary tube 103 are forcedly in contact with each other, namely, welded with pressure in the parallel attached state. For this, the entire length of the work piece maintaining device is nearly equal to the coil length of the high frequency induction heating coil 700.

Because the work piece maintaining device plays an important role in manufacturing the heat exchanger 106A by the high frequency induction heating method which is the second manufacturing method, referring to FIGS. 9 and 10, the present invention will be described in more detail. In FIGS. 9 and 10, in order to simplify the drawings, the suction pipe pressing member 810 is indicated as a suction pipe contact portion 811 and the capillary tube pressing member 820 is indicated as a capillary tube contact portion 821. Additionally, the support member 830 is indicated as the suction pipe bottom face supporting portion 831 and the capillary tube bottom face supporting member 833. In addition, a pressing direction of the suction pipe pressing member 810 is indicated as an arrow (→) directed from the left to the right in the drawing, and a pressing direction of the capillary tube pressing member 820 is indicated as an arrow (←) directed from the right to the left in the drawing. Moreover, in FIGS. 9 and 10, the brazing material 502 is not illustrated.

In order to weld the external surface of the aluminum-made suction pipe 105 and the external surface of the aluminum-made capillary tube 103 with pressure, brazing is carried out as shown in FIG. 9. That is, the suction pipe pressing member 810 (suction pipe contact portion 811 in the drawing) presses the side of the suction pipe 105 in a horizontal direction (the arrow (→) directed from the left to the right in the drawing) toward the center (OS) of the suction pipe, and the capillary tube pressing member 820 (capillary tube contact portion 821 in the drawing) presses the side of the capillary tube 103 in a horizontal direction (the arrow (←) directed from the right to the left in the drawing) toward the center (OC) of the capillary tube 103.

As described above, in the case that the pressing member presses horizontally toward the center, according to the principle, the support member 830 (the suction pipe bottom face supporting portion 831 and the capillary tube bottom face supporting portion 833 in the drawing) is not needed, but is stable if it is used. The degree of safety depends on the area that the suction pipe contact portion 811 and the capillary tube contact portion 821 are respectively in contact with the side of the suction pipe 105 and the side of the capillary tube 103, but in the view point of thermal efficiency, it is preferable that the contact area is small if possible. When the contact area is small, one or both sides of the work piece 501 may drop in an upward direction.

Accordingly, as shown in FIG. 10, the suction pipe pressing member 810 (the suction pipe contact portion 811 in the drawing) presses the side of the suction pipe 105 diagonally downward (in the diagonal arrow direction from the upper side of the left to the lower side of the right in the drawing) toward the center (OS) of the suction pipe. Furthermore, the capillary tube pressing member 820 (the capillary tube contact portion 821 in the drawing) presses the side of the capillary tube 103 diagonally downward (in the diagonal arrow direction from the upper side of the right to the lower side of the left in the drawing) toward the center (OC) of the capillary tube. After that, it is preferable that the support member 830 (the suction pipe bottom face supporting portion 831 and the capillary tube bottom face supporting portion 833 in the drawing) is disposed. Through the above structure, while the suction pipe 105 and the capillary tube 103 are moved in safety in the state where their external surfaces are welded with pressure, the external surfaces of the aluminum-made suction pipe 105 and the aluminum-made capillary tube 103 to which the brazing material is supplied are heated by the high frequency induction heating coil 700, so that the brazing material is melted and the fillets (not shown) are formed at the connected portions.

As shown in FIGS. 9 and 10, the contact portions of the suction pipe contact portion 811 and the capillary tube contact portion 821 are in an R-shaped form which is the same as the side of the suction pipe 105 and the side of the capillary tube 103. Moreover, upper portions of the suction pipe contact portion 811 and the capillary tube contact portion 821 are bent toward the outside, so that the work piece 501 can be moved smoothly.

The material for the work piece maintaining device is not specially restricted, but preferably, a material which does not generate heat or is difficult to generate heat by the high frequency induction heating is used. Particularly, it is preferable that the members (the suction pipe contact portion 811, the capillary tube contact portion 821, the suction pipe bottom face supporting portion 831, and the capillary tube bottom face supporting portion 833) which are in contact with the work piece 501 of the work piece maintaining device are made of a material which does not generate heat by the high frequency induction heating, for instance, non-magnetic ceramic.

Returning to FIG. 7, a process of preparing the work piece on the jig is not illustrated in the drawing. If the jig can keep the state where the suction pipe 105 and the capillary tube 103 are attached in parallel, the jig which arranges the work pieces 501, namely, the suction pipe 105 and the capillary tube 103, in the parallel attached state may adopt any structure. Here, the jig has the same structure as the work piece maintaining device.

The aluminum-made suction pipe 105 of 3,000 mm and the aluminum-made capillary tube 103 of 3,000 mm which are attached in parallel are called the work piece 501, and the work piece 501 is maintained on the jig which has the same structure as the work piece maintaining device. Here, because the high frequency induction heating coil 700 is 20 cm in length, the entire length of the jig which is the work piece maintain device is about 20 cm. In the meantime, the brazing material is supplied to the work piece 501 and flux is coated thereon, but because it is identical with the description of the first manufacturing method, its detail description will be omitted.

Lids made of heat-resistant resin (not shown), each of which has a thin steel wire mounted at one end, are respectively inserted into opening portions of the suction pipe 105 and the capillary tube 103, and the front end of the wire passes through the work piece maintaining device illustrated in FIG. 7, and then, is connected to a driving device (not shown) arranged on the outside of the high frequency induction heating coil 700 in the arrow direction (from the right to the left in FIG. 7). The heat-resistant resin lids, the thin steel wire, and the driving device function as means for returning the work piece 501 prepared on the jig to the work piece maintaining device illustrated in FIG. 7 (hereinafter, called ‘returning means’).

Not shown in the drawing, but the jig on which the work piece 501 is prepared and the work piece maintaining device of FIG. 7 are arranged in series. The work piece 501 prepared on the jig is in the state where the external surface of the suction pipe 105 and the external surface of the capillary tube 103 are welded with pressure. In this state, the work piece 501 is returned to the work piece maintaining device of FIG. 7 by the returning means.

It is preferable that frequency used for brazing by the high frequency induction heating method, which is the second manufacturing method, is 20 kHz to 200 kHz and the heating output is 20 kW to 40 kW. Furthermore, the returning speed by the work piece returning means is varied according to kinds of the brazing material and the heating output, but is about 0.5 m/minute to 15 m/minute.

After the work piece 501 is returned to the work piece maintaining device, one side of the work piece 501, namely, the side of the suction pipe 105, is pressed toward the other side of the work piece 501, namely, the side of the capillary tube 103 by the suction pipe pressing member 810. Additionally, the side of the capillary tube 103 is pressed toward the side of the suction pipe 105 by the capillary tube pressing member 820. As described above, because the sides of the suction pipe 105 and the capillary tube 103 are pressed, the external surface of the suction pipe 105 and the external surface of the capillary tube 103 are heated in the state where they are welded with pressure, namely, in the contact state. The brazing material 502 starts to be gradually melted from the vicinity of an inlet of the high frequency induction heating coil 700 (right side in FIG. 7), and then, is completely melted in the vicinity of an outlet of the high frequency induction heating coil 700 so as to form the fillets 201. Here, for the brazing material, the Al—Si alloy of the thin linear type was used, and noncorrosive fluoride flux was used. Moreover, in order to raise the brazing temperature to 602° C.±5° C., the heating output was 20 kW, and the returning speed of the work piece was 0.5 m/minute.

The work piece 501 discharged from the high frequency heating coil 700 is gradually cooled at room temperature so as to be coagulated into the fillets 201. Because there is no pin hole at the connected portion of the aluminum-made suction pipe 105 and the aluminum-made capillary tube 103, brazing is carried out continuously. Furthermore, because the work piece 501 is gradually cooled, a bending process can be easily carried out due to an annealing effect.

The heat exchanger 106A can be manufactured by the laser brazing method. That is, the brazing material selected from the Ai—Si alloy or the Zn—Al alloy is supplied to the connected portions, and the aluminum-made suction pipe and the aluminum-made capillary tube are coated with flux. After that, in the state where the aluminum-made suction pipe and the aluminum-made capillary tube are attached in parallel, the brazing material is melted by laser beams, which is a heat source for heating the brazing material so as to form the fillets at the portion where the suction pipe and the capillary tube are joined, and then, is cooled so as to coagulate the fillets. In the manufacturing method of the heat exchanger for the refrigeration cycle according to the present invention by the laser brazing method, a refrigerant discharged from a compressor is circulated, in order, to a condenser, a capillary tube, an evaporator, a suction pipe, and the compressor, and the external surface of the capillary tube and the external surface of the suction pipe are thermally in contact with each other. The manufacturing method of the heat exchanger for the refrigeration cycle according to the present invention includes:

1) a process of preparing a work piece on a jig:

(a) the work piece is arranged on the jig in a state where the aluminum-made suction pipe and the aluminum-made capillary tube are attached in parallel; and

(b) the work piece is coated with flux to which a brazing material selected from an Al—Si alloy or a Zn—Al alloy is supplied;

2) a process of radiating laser beams to the brazing material while the work piece prepared on the jig moves relatively to the laser beams, so that the brazing material is melted so as to form fillets on the portion where the suction pipe and the capillary tube are joined; and

3) a process of cooling the work piece so as to coagulate the fillets.

Therefore, the heat exchanger for the refrigeration cycle is manufactured by the laser brazing method including the 1) to 3) processes.

When the heat exchanger 106A is manufactured by the laser brazing method, the work piece prepared on the jig is identical with the work piece 501 of the first manufacturing method. Like the first manufacturing method, the work piece prepared on the jig is prepared in the state where the aluminum-made suction pipe and the aluminum-made capillary tube are attached in parallel. In the above state, laser beams are radiated to the brazing material, so that the brazing material is melted so as to form the fillets at the portion where the suction pipe and the capillary tube are joined.

Like the second manufacturing method, for brazing, laser beams may be radiated to the brazing material in the state where the external surfaces of the aluminum-made suction pipe and the aluminum-made capillary tube forcedly abut on each other, namely, in the state where the external surfaces are welded with pressure. In this instance, as the jig, the work piece maintaining device used in the second manufacturing method may be used, or the pressure jig may be used.

In order to radiate laser beams, the laser welding machine used in the third manufacturing method may be used. In the case that the Al-Si alloy is used for the brazing material, the laser beam radiation condition is the same as the third manufacturing method.

Next, referring to the drawings, the heat exchanger 106B, in which the external surface of the aluminum-made capillary tube 103 and the external surface of the aluminum-made suction pipe 105 are joined in the state where the external surfaces of the capillary tube 103 and the suction pipe 105 are melted, and a representative manufacturing method of the heat exchanger 106B will be described.

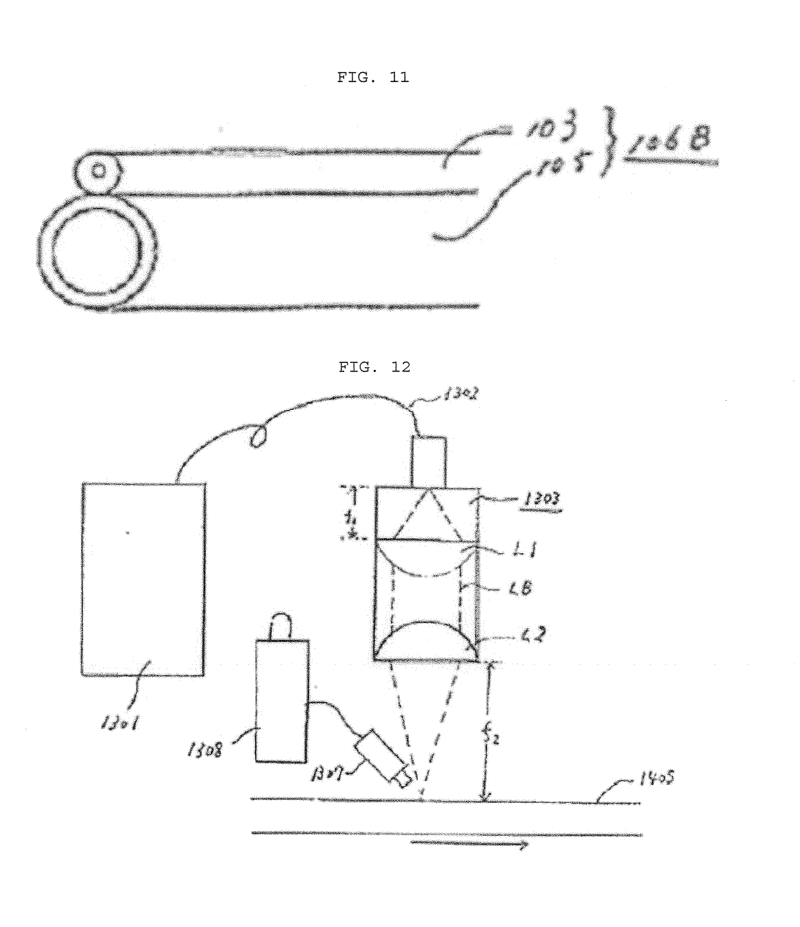

The configuration of the refrigeration cycle using the heat exchanger 106B according to the present invention is the same as the refrigeration cycle illustrated in FIG. 1, and hence, its detailed description will be omitted. In the refrigeration cycle, the heat exchanger 106B (see FIG. 11) is configured with the aluminum-made suction pipe 105 and the aluminum-made capillary tube 103. In the heat exchanger 106B, the external surface of the aluminum-made capillary tube 103 and the external surface of the aluminum-made suction pipe 105 are joined with each other in the state where the external surfaces of the capillary tube 103 and the suction pipe 105 are melted.

FIG. 11 is a perspective view of the heat exchanger in which the connected portions are melted and connected together. The capillary tube 103 and the suction pipe 105 of the heat exchanger 106B according to the present invention are respectively made of aluminum. Because the external surface of the aluminum-made capillary tube 103 and the external surface of the aluminum-made suction pipe 105 are joined with each other in the state where the external surfaces of the capillary tube 103 and the suction pipe 105 are melted by radiation of laser beams, the capillary tube 103 and the suction pipe 105 are in thermal contact with each other.

Except that the capillary tube 103 and the suction pipe 105 of the heat exchanger 106 are made of aluminum, they are almost identical in shape, length, outer diameter and inner diameter with the capillary tube and the suction pipe of the existing freezers, refrigerators, and refrigeration devices. Additionally, the aluminum material for the suction pipe 105 and the capillary tube 103 may be aluminum or aluminum alloy.

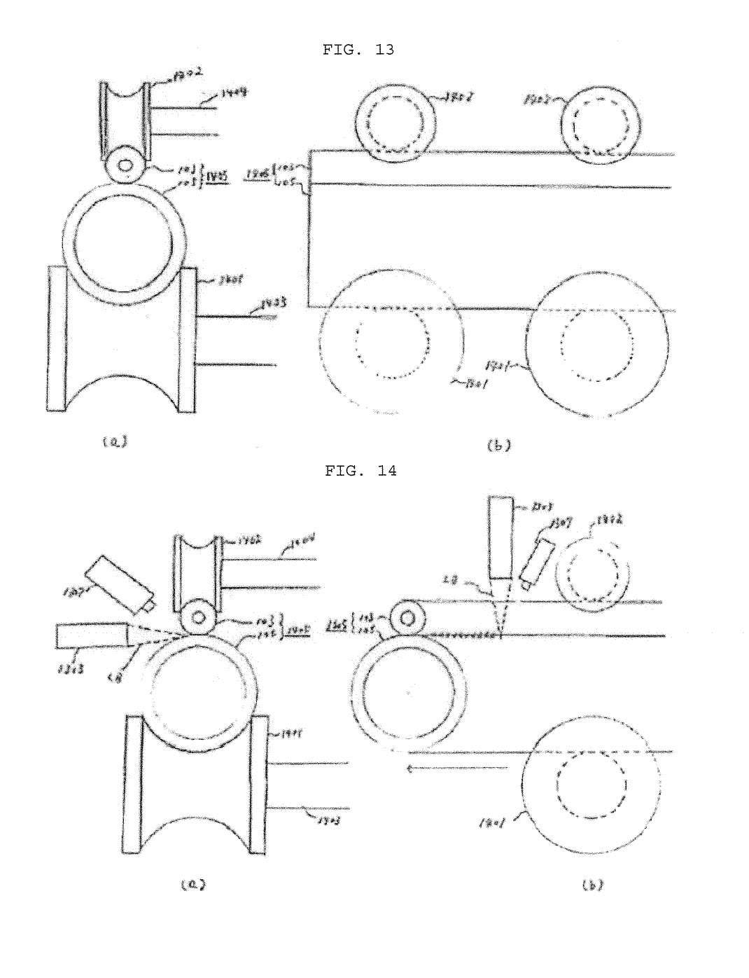

FIG. 12 is a conceptual diagram of a laser welding machine used when the heat exchanger 106B according to the present invention is manufactured. Here, a fiber laser welding machine is illustrated as the laser welding machine. The reference numeral 1301 designates a fiber laser main body, 1302 designates optical fiber (fiber diameter is Φ), and 1303 designates a laser beam radiation unit. Laser beams (LB), which are indicated by broken lines in the drawing, induced to the laser beam radiation unit 1303 are configured to become parallel beams by a lens L1 (focal distance is f₁), and to be collected by another lens L2 (focal distance is f₂), so that the laser beams (LB) of a predetermined spot diameter are radiated to a work piece 1405 (See FIG. 13) moving in one direction relative to the laser beams (LB).

In the meantime, while the work piece 1405 is pressed by pressure rollers 1401 and 1402, the external surfaces of the aluminum-made suction pipe 105 and the aluminum-made capillary tube 103 are welded with pressure (See FIG. 13), but in the drawings, it is illustrated with simplicity. In the drawing, the work piece 1405 is moved in an arrow (→) direction (from the left to the right in the drawing). The reference numeral 1308 designates a nitrogen bombe, and 1307 designates a nitrogen gas injection nozzle. In laser welding, inert gas, such as argon gas, may be used in order to prevent oxidation of the work piece 1405.

FIG. 13 is a view showing a state where the pressure rollers 401 and 402 which are pressing jigs press the work piece 405 (which means a state where the aluminum-made suction pipe 105 and the aluminum-made capillary tube 103 are attached to each other in parallel) so that the external surfaces of the suction pipe and the capillary tube are welded with pressure by the pressure rollers, wherein FIG. 13(a) is a side elevation view and FIG. 13(b) is a plan view.

The pressure roller 1401 presses the side of the suction pipe 105 toward the capillary tube 103. The pressure roller 1401 is a roller which has an arc-shaped recess formed in correspondence with the outer diameter of the suction pipe 105. The pressure roller 1402 presses the side of the capillary tube 103 toward the suction pipe 105. The pressure roller 1402 is a roller which has an arc-shaped recess formed in correspondence with the outer diameter of the capillary tube 103. The reference numeral 1403 designates a shaft of the pressure roller 1401, and 1404 designates a shaft of the pressure roller 1402. At least one side of the shaft 1403 and the shaft 1404 is fixed in such a way as to be adjustable in position in a vertical direction (a direction of a line passing central points of the suction pipe 105 and the capillary tube 103) to an axial direction of a housing (not shown).

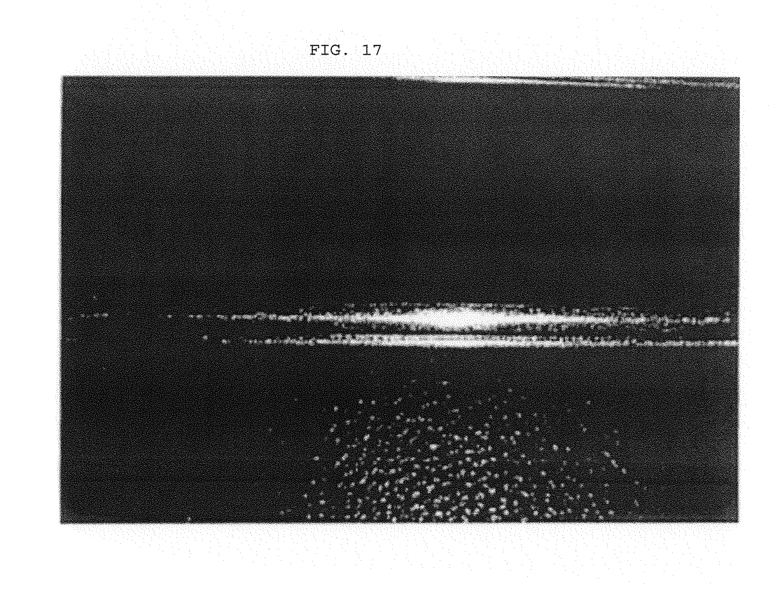

In FIG. 13, two pairs of the pressure rollers 1401 and 1402 disposed at a proper spaced interval from each other press the work piece 1405 so as to weld the external surfaces of the suction pipe 105 and the capillary tube 103 with pressure, but the present invention is not restricted to the above. For instance, a pair of the pressure rollers 1401 and 1402 may press the work piece 1405 so as to weld the external surfaces of the suction pipe 105 and the capillary tube 103 with pressure. Moreover, according to the method of automatically manufacturing the heat exchanger 106B as shown in FIG. 16, a pair of the pressure rollers 1401 and 1402 and a pair of guide rollers 1701 and 1702 form the pressure jig, and the pressure jig presses the work piece 1405 so that the external surfaces of the suction pipe 105 and the capillary tube 103 are welded with pressure. The pressure rollers 1401 and 1402 may be made of copper, brass or aluminum which provides excellent thermal conductivity, or may be made of polymer, such as urethane.

FIG. 14 is a mimetic diagram for showing the manufacturing method of the heat exchanger according to the present invention, wherein FIG. 14(a) is a side elevation view and FIG. 14(b) is a plan view. In FIG. 14, a pair of pressure rollers 1401 and 1402 press the work piece 1405 so that the external surfaces of the suction pipe 105 and the capillary tube 103 are welded together with pressure, and then, laser welding is carried out while nitrogen gas is injected. The work piece 1405 is moved in an arrow (←) direction relative to the laser beams (LB) (from the right to the left in the drawing). The movement speed of the work piece 1405 becomes faster when output of the fiber laser becomes larger, but the standard of the movement speed of the work piece 1405 is about 3 m/minute to 5 m/minute when the peak output of the fiber laser is about 1000 W.

It is preferable that the laser beams (LB) to the work piece 1405 are radiated in an inclined direction to the work piece 1405 in order to avoid light returning from the work piece 1405. The laser beam radiation unit 1303 is inclined toward the upstream side of the movement direction of the work piece (in this instance, the laser beams (LB) are radiated toward the front side of the heading direction of the work piece 1405), or inclined toward the downstream side of the movement direction of the work piece (in this instance, the laser beams (LB) are radiated toward the rear side of the heading direction of the work piece 1405).

It is preferable that a radiation location of the laser beams (LB) to the work piece 1405 is within a range from the position where a pair of the pressure rollers 1401 and 1402 press the work piece 1405 to a position directly next to the downstream side of the work piece movement direction, and more preferably, the radiation location of the laser beams (LB) to the work piece 1405 is the position where a pair of the pressure rollers 1401 and 1402 press the work piece 1405. Moreover, in the case that two pairs of the pressure rollers 1401 and 1402 press the work piece 1405 so that the external surfaces of the suction pipe 105 and the capillary tube 103 are welded together with pressure, it is preferable that the radiation location of the laser beams (LB) is within a range from the position where the pressure rollers 1401 and 1402 located at the downstream side of the work piece movement direction press the work piece 1405 to the position directly next to the downstream side of the work piece movement direction. More preferably, the radiation location of the laser beams (LB) is the position where the pressure rollers 1401 and 1402 located at the downstream side of the work piece movement direction press the work piece 1405.

In the meantime, in FIG. 14(b), it is illustrated that the radiation location of the laser beams (LB) is more downward than the position directly next to the downstream side of the work piece movement direction, which is the position where a pair of the pressure rollers 1401 and 1402 press the work piece 1405. The reason is to draw the laser beam radiation unit 1303 and the nitrogen gas injection nozzle 1307 on the same plane for convenience sake.

Not shown in the drawing, in a device in which the work piece is pressed and fixed by the pressure jig and moves together with the pressure jig in one direction relative to the laser beams, the radiation location of laser beams to the work piece in the work piece movement direction may be set to a certain location.

It is preferable that an injection location of the nitrogen gas injected from the nitrogen gas injection nozzle 1307 toward the work piece 1405 is nearly the same as the radiation location of the laser beams (LB). Furthermore, it is preferable that the injection direction of nitrogen gas is the same as the movement direction of the work piece 1405. When nitrogen gas is injected in the above direction, the connected portions directly after welding are covered with a nitrogen gas atmosphere so as to securely block it from oxygen. A flow rate of nitrogen gas is about 101/minute (10 liter per minute). Meanwhile, in FIG. 14(b), the signal of xxxxx at the contact portions of the suction pipe 105 and the capillary tube 103 indicates the state where the external surfaces of the suction pipe 105 and the capillary tube 103 are melted and connected by laser beam welding.

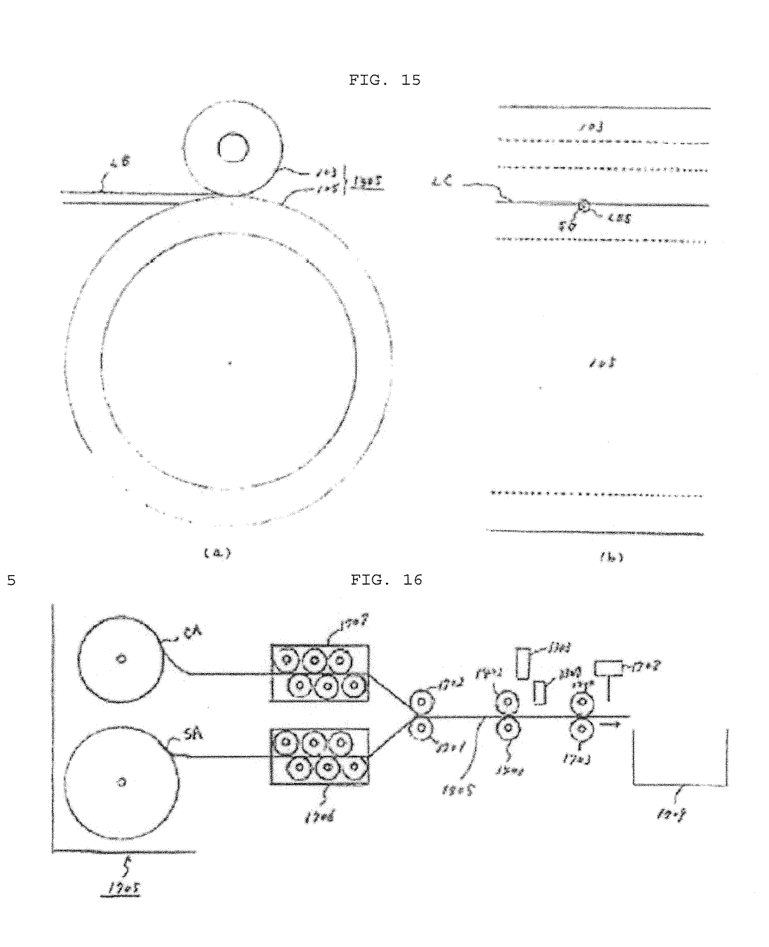

FIG. 15 is an enlarged view showing a state where laser beams (LB) are radiated to the work piece 1405 on which the external surface of the suction pipe 105 and the external surface of the capillary tube 103 are welded with pressure, wherein FIG. 15(a) is a side view and FIG. 15(b) is a plan view. In order to connect the external surfaces of the suction pipe 105 and the capillary tube 103 by laser beam welding, laser beams are radiated to the portion where the external surfaces of the suction pipe 105 and the capillary tube 103 are in contact with each other. In other words, laser beams (LB) are radiated in such a manner that a contact line (LC) formed when the external surfaces of the suction pipe 105 and the capillary tube 103 are welded with pressure is interposed therebetween. The spot diameter of the laser beam spot (LBS) is about Φ0.05 mm to 0.6 mm.

It is preferable that the radiation location of the laser beams (LB) to the work piece 1405 is leaned to the suction pipe 105 as shown in FIG. 15(b). In other words, it is preferable that the spot center (S0) of the laser beams (LB) is more leaned to the suction pipe 105 than the contact line (LC). Numerically, the spot center (S0) of the laser beams (LB) is leaned to the suction pipe within a range of the spot diameter (Φ)×⅙ to the spot diameter (Φ)×⅓ on the basis of the contact line (LC).

FIG. 16 is a conceptual diagram showing a method of automatically manufacturing the heat exchanger. The reference numerals 1703 and 1704 designate driving rollers, 1401 and 1402 designate pressure rollers, and 1701 and 1702 designates guide rollers. An uncoiler 1705 includes an aluminum tube (CA) for the capillary tube and an aluminum tube (SA) for the suction pipe, which are wound in a coil type. The driving roller 1703 and 1704 driven by a motor (not shown) transfer the work piece 1405 in a → direction (from the left to the right in the drawing). The aluminum tube (SA) for the suction pipe and the aluminum tube (CA) for the capillary tube which are drawn out from the uncoiler 1705 are wound and corrected while passing through correction devices 1706 and 1707 arranged at the downstream side, and then are induced to the guide rollers 1701 and 1702. In the state where the aluminum tube (SA) for the suction pipe and the aluminum tube (CA) for the capillary tube are attached in parallel by the guide rollers 1701 and 1702, they are transferred in the direction of the pressure rollers 1401 and 1402 arranged at the downstream side.

The guide rollers 1701 and 1702 and the pressure rollers 1401 and 1402 arranged at the downstream side form the pressure jig, and the pressure jig presses the work piece 1405, so that the external surface of the aluminum tube (SA) for the suction pipe and the external surface of the aluminum tube (CA) for the capillary tube are welded together with pressure. The laser beam radiation unit 1303 is arranged in such a way as to radiate the laser beams (LB) to the position where a pair of the pressure rollers 1401 and 1402 press the work piece 1405.

The nitrogen gas injection nozzle 1307 is arranged in such a manner that the injection direction is the same as the movement direction of the work piece 1405 and the injection position of nitrogen gas to the work piece 1405 is nearly the same as the radiation position of the laser beams (LB). The welded work piece is cut to a predetermined length by a cutter 1708 arranged at the downstream side of the driving rollers 1703 and 1704. The heat exchanger 106B manufactured as described above is loaded on a stocker 1709.

FIG. 17 is a photograph of the heat exchanger 106B manufactured by connecting the aluminum-made suction pipe and the aluminum-made capillary tube using the fiber laser welding machine.

Aluminum-made suction pipe: Φ6.4 mm in outer diameter, 0.7 mm in thickness, Φ5 mm in inner diameter

Aluminum-made capillary tube: Φ2 mm in outer diameter, 0.7 mm in thickness, Φ0.6 mm in inner diameter

Fiber laser welding machine: 1070 nm to 1100 nm in oscillation wavelength, Φ0.1 mm in fiber diameter of an optical fiber 302, 100 mm in focal distance(f₁) of lens(L1), 200 mm in focal distance(f₂) of lens(L2), Φ0.2 mm in laser beam spot diameter, and 800 W in peak output

The laser beam spot diameter was Φ0.2 mm, the focal location was the surface of the work piece 1405. On the basis of the contact line (LC) (See FIG. 15), the spot center of the laser beams (LB) was adjusted in such a way as to be biased toward the suction pipe by 0.05 mm, and the radiation location of the laser beams (LB) in the work piece movement direction relative to the work piece 1405 was adjusted to the position where the pressure rollers 1401 and 1402 press the work piece 1405. The pressure rollers 1401 and 1402 were made of copper. The movement speed of the work piece 1405 was 30 mm/second and 50 mm/second. Furthermore, nitrogen gas whose flow rate was 101/minute (10 liter per minute) was used as shielding gas, and was injected in the same direction as the movement direction of the work piece 405.

The heat exchanger obtained by connecting the aluminum-made suction pipe and the aluminum-made capillary tube with each other suffers nothing by comparison with a conventional heat exchanger obtained by soldering the copper-made suction pipe and the copper-made capillary tube. cl INDUSTRIAL APPLICABILITY

The heat exchanger according to the present invention is applicable to freezers, refrigerators, and so on.

We claim:

1.-7. (canceled)

8. A heat exchanger for a refrigeration cycle which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other,
wherein the material of both the capillary tube and the suction pipe is aluminum, and the locations at which the external surface of the capillary tube and the external surface of the suction pipe are joined are in a state where the external surfaces are melted.

9. A heat exchanger for a refrigeration cycle which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other,
wherein the material of both the capillary tube and the suction pipe is aluminum, and the locations at which the external surface of the capillary tube and the external surface of the suction pipe are joined are in a state where the external surfaces are melted by radiating laser beams.

10. The heat exchanger for a refrigeration cycle of according to claim 9, wherein the laser beams are fiber laser beams.

11. A manufacturing method of a heat exchanger for a refrigeration cycle, which is configured so that a refrigerant discharged from a compressor is circulated, in order, to a condenser, a capillary tube, an evaporator, a suction pipe, and the compressor, and so that the external surface of the capillary tube and the external surface of the suction pipe are thermally in contact with each other, the manufacturing method comprising:
i) pressing an aluminum-made suction pipe and an aluminum-made capillary tube by a pressure jig in a state where they are attached in parallel, so as to welding the external surfaces of the suction pipe and the capillary tube together with pressure; and
ii) radiating laser beams to the portion where the external surface of the suction pipe and the external surface of the capillary tube are joined while relatively moving along the laser beams in the state where the external surfaces of the suction pipe and the capillary tube are welded together with pressure, so that the external surfaces are melted and connected together.

12. The manufacturing method of a heat exchanger for a refrigeration cycle according to claim 11, wherein the laser beams are fiber laser beams.

13. The manufacturing method of a heat exchanger for a refrigeration cycle according to claim 12, wherein the fiber laser beams are inclined toward the upstream or the downstream of the relatively moving direction and the locations at which the external surface of the capillary tube and the external surface of the suction pipe are joined are in a state where the external surfaces are radiated.
